(19) United States
(12) Patent Application Publication
(10) Pub. No.: US 2021/0084717 A1
(43) Pub. Date: Mar. 18, 2021

(54) LIFE JACKET HAVING FUNCTION OF MAINTAINING BODY TEMPERATURE

(71) Applicant: DPT CO., LTD., Seoul (KR)

(72) Inventor: Eung Joon LEE, Seoul (KR)

(21) Appl. No.: 16/686,788

(22) Filed: Nov. 18, 2019

(30) Foreign Application Priority Data
Sep. 18, 2019 (KR) 10-2019-0114768

(51) Int. Cl. H05B 1/02; B63C 9/125

(52) U.S. Cl. CPC H05B 1/0288; B63C 9/1255

(57) ABSTRACT

Provided is a life jacket having a function of maintaining body temperature and preventing a drowning accident when water distress occurs. The life jacket includes: an inflatable buoyant member configured to be inflated to provide buoyancy; a jacket including a sealed bag, and being wearable on an upper body of a user; a vacuum pack having a spout and provided inside the sealed bag, the spout being configured such that an end thereof is exposed to an outside of the jacket; a self-triggering inflating body provided inside the vacuum pack; a heating element configured to generate heat by reacting with water flowing into the vacuum pack; and an interlock-type opening member, which is configured to open a stopper by being in conjunction with inflation of the inflatable buoyant member, the stopper being configured to normally close an inlet opening of the spout.

### BACKGROUND OF THE INVENTION

### Field of the Invention

The present disclosure relates to a life jacket preventing drowning in water distress. More particularly, the present disclosure relates to a life jacket having a function of maintaining body temperature, wherein a heating element generates heat in water distress to prevent death from hypothermia, the heating element generates heat by being operated by a mechanical structure without an electrical structure, and the heating element does not malfunction due to wearer's sweat or rain water that is unrelated to water distress.

### Description of the Related Art

Generally, a life jacket is a jacket-type aid equipment worn float a wearer's body for safety when a wearer falls into water during swimming, water leisure sports, or fishing on waters such as rivers, lakes, and seas.

Most of the deaths of a water distress person wearing a life jacket are caused by hypothermia due to the loss of body temperature of the distressed person in water.

In Korean Application Publication No. 10-2013-0041705 “Life jacket” and Korean Application Publication No. 10-2019-0061861 “Smart life jacket to maintain constant temperature for long time”, life jackets are disclosed, the life jackets being provided with heating means to maintain the body temperature of the distressed wearer so as to prevent death from hypothermia before rescue.

However, the conventional life jackets adopt an electrical structure as the heating means. That is, the conventional life jackets consist of the electrical structure such as a battery supplying power, a heating element generating heat when power is supplied (e.g., a heating wire and a planar heating element), a switch allowing power of the battery to be supplied to the heating element, a sensor, and the like.

The heating means having this electrical structure has problems of electric shock during actual operation of the life jacket, of malfunction, and of inconvenience of checking in advance whether the battery is discharged or is normally operated.

In the conventional life jackets, there is a life jacket having a heating element as the heating means. The heating element generates heat by reacting with water. When the life jacket is wet with water in water distress, the water contacts with the heating element provided inside the life jacket and the heating element generates heat by chemical reaction.

However, the conventional life jacket using the heating element reacting with water is not useful because the life jacket may also be operated when wearer's sweat or natural rain water penetrates into the life jacket.

### SUMMARY OF THE INVENTION

Accordingly, the present disclosure has been made keeping in mind the above problems occurring in the related art, and the present disclosure is intended to propose a life jacket having a function of maintaining body temperature. The life jacket is provided to remove inconvenience concern about electric shock or whether the life jacket is normally operated by using a mechanical structure without an electrical structure, and the life jacket is configured to prevent malfunction by preventing a heating element reacting with water from contacting with sweat or rain water in non-distress situation.

In order to achieve the above object, according to one aspect of the present disclosure, there is provided a life jacket having a function of maintaining body temperature. the life jacket including: an inflatable buoyant member configured to be inflated to provide buoyancy; a jacket including a sealed bag, and being wearable on an upper body of a user; a vacuum pack having a spout and provided inside the sealed bag, the spout being configured such that an end thereof is exposed to an outside of the jacket; a self-triggering inflating body provided inside the vacuum pack; a heating element configured to generate heat by reacting with water flowing into the vacuum pack; and an interlock-type opening member, which is configured to open a stopper by being in conjunction with inflation of the inflatable buoyant member, the stopper being configured to normally close an inlet opening of the spout.

Further, the life jacket having a function of maintaining body temperature may include: a cylinder provided in an internal passage of the spout; and a first check valve configured to open and close a flow path of the cylinder by using pressure difference, the flow path connecting the inlet opening of the spout to an inside of the vacuum pack.

When pressure inside the vacuum pack is increased due to reaction of the heating element, the cylinder may be moved forward to the inlet opening of the spout along the internal passage of the spout, and a locking structure may be provided on each of an inner wall of the spout and an outer wall of the cylinder so that the inner wall of the spout and the outer wall of the cylinder may be locked to each other by the locking structure.

The spout may include a second check valve, the second check valve being configured to be opened when pressure inside the vacuum pack is increased, thereby allowing water vapor generated by the heat of the heating element to be discharged to the sealed bag.

As described above, the life jacket having a function of maintaining body temperature of the present disclosure is configured such that the heating element generates heat by being operated by the mechanical structure. Accordingly, the life jacket can generate heat even during lack of power or failure, there is no need to check frequently whether the life jacket is normally operated, and it is possible to prevent the malfunction of the life jacket in which the heating element generates heat when the life jacket is wet with water in a situation which is not the distress related to water. Therefore, the life jacket having a function of maintaining body temperature is useful for industrial development.

### BRIEF DESCRIPTION OF THE DRAWINGS

The above and other objects, features and other advantages of the present disclosure will be more clearly understood from the following detailed description when taken in conjunction with the accompanying drawings, in which:

FIGS. 1A and 1B are views showing an example of a life jacket having a function of maintaining body temperature according to the present disclosure, the views showing before and after inflation of an inflatable buoyant member provided inside a neck part of a jacket; and

FIGS. 2A and 2C are views showing a structure of main components of present disclosure and showing an operational mechanism when the inflatable buoyant member is inflated.

### DETAILED DESCRIPTION OF THE INVENTION

Hereinbelow, an exemplary embodiment of the present disclosure will be described in detail with reference to the accompanying drawings.

Prior to the detailed description of a life jacket having a function of maintaining body temperature according to present disclosure, the present disclosure will now be described in detail on the basis of aspects (or embodiments). The present disclosure may, however, be embodied in many different forms and should not be construed as being limited to only the embodiments set forth herein, but should be construed as covering modifications, equivalents or alternatives falling within ideas and technical scopes of the present disclosure.

In the figures, like reference numerals, particularly, reference numerals having the same last two digits or the same last two digits and letters refer to like elements having like functions throughout, and unless the context clearly indicates otherwise, elements referred to by reference numerals of the drawings should be understood on the basis of this standard.

Also, for convenience of understanding of the elements, in the figures, sizes or thicknesses may be exaggerated to be large (or thick), may be expressed to be small (or thin) or may be simplified for clarity of illustration, but due to this, the protective scope of the present disclosure should not be interpreted narrowly.

The terminology used herein is for the purpose of describing particular aspects (or embodiments) only and is not intended to be limiting of the present disclosure. As used herein, the singular forms are intended to include the plural forms as well, unless the context clearly indicates otherwise.

It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

As shown in the drawings, the life jacket having a function of maintaining body temperature according to the present disclosure includes: an inflatable buoyant member 20; a jacket 10; a vacuum pack 30; a self-triggering inflating body 40; a heating element 50; an interlock-type opening member 60; a cylinder 70; a first check valve 80; and a second check valve 90.

The jacket 10 is wearable on an upper body of a user. The jacket 10 includes a back part 11 covering a back of the user and a front part 12 covering a chest of the user, a function of the each part being based on a positioning thereof, and the jacket 10 may include a neck part 13 covering a neck of the user.

The jacket 10 includes a sealed bag 17 and an outer cover 15 covering the sealed bag 17 for protection. The outer cover 15 is provided with a buckle, a zipper, and the like to fasten opposite front parts 12 together. A buoyant material may be provided inside the outer cover 15 to provide buoyancy.

Preferably, the outer cover 15 may be made of a material having an excellent heat insulation property and thermokeeping property. The sealed bag 17 is configured to store water vapor that is generated when the heating element 50 reacts with water not to be discharged.

Preferably, the sealed bag 17 may be made of a material having excellent heat resistance and durability. A polypropylene (PP) bag may be used as the above-described sealed bag 17.

The sealed bag 17 may be preferably configured such that opposite sides thereof are attached to each other at various inside portions of the opposite sides. Accordingly, the sealed bag 17 may be inflated to have an overall uniform thickness when the sealed bag 17 is inflated by being filled with water vapor. The sealed bag 17 may be preferably provided with an over-pressure prevention check valve (not shown) to prevent over-inflation and bursting of the sealed bag 17 due to water vapor, the over-pressure prevention check valve being configured to be opened over a predetermined pressure to discharge water vapor inside the sealed bag 17 to the outside.

The inflatable buoyant member 20 is configured to inflate to provide buoyancy.

The inflatable buoyant member 20 may be a floating tube having a hose. In this case, the user can inflate the floating tube by blowing air into the hose by user's mouth.

The inflatable buoyant member 20 may be a floating tube provided with a compressed gas container and an operation button. When the user presses the operation button in a distress situation, gas may be discharged from the compressed gas container to inflate the floating tube.

In addition, various types of inflatable buoyant members 20 may be used in the life jacket. The inflatable buoyant member 20 may be configured to be inflated not only by user's manual operation but also by automatic operation under specific conditions.

The inflatable buoyant member 20 may be provided inside the neck part 13 or the back part 11 of the jacket 10, or may be provided as a separate product from the jacket 10.

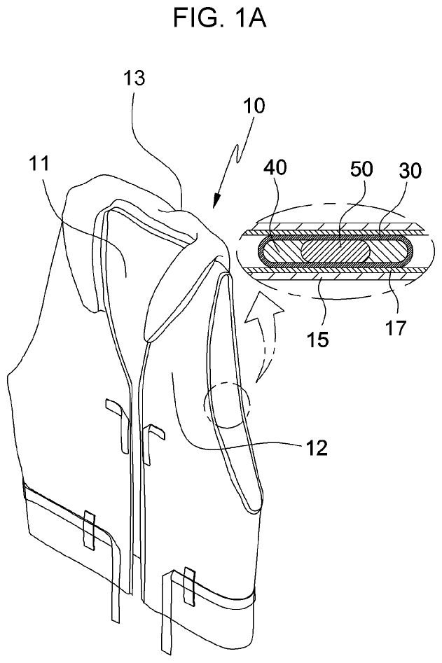

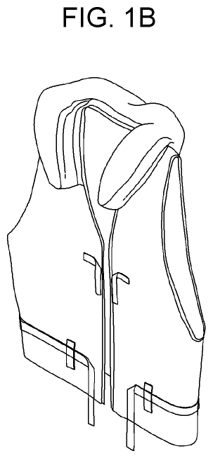

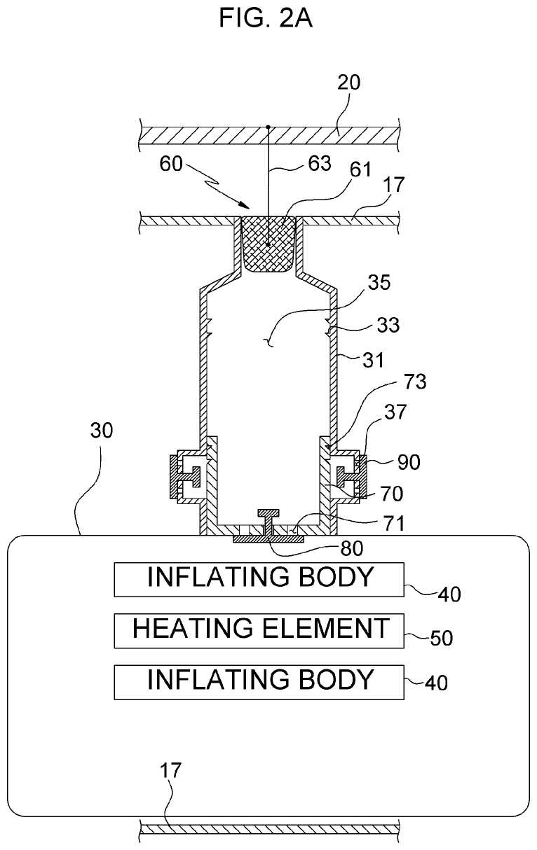

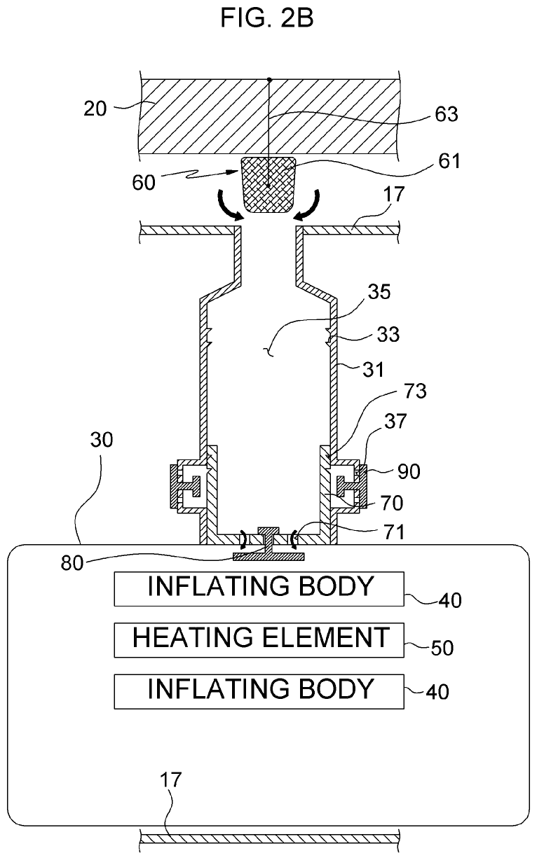

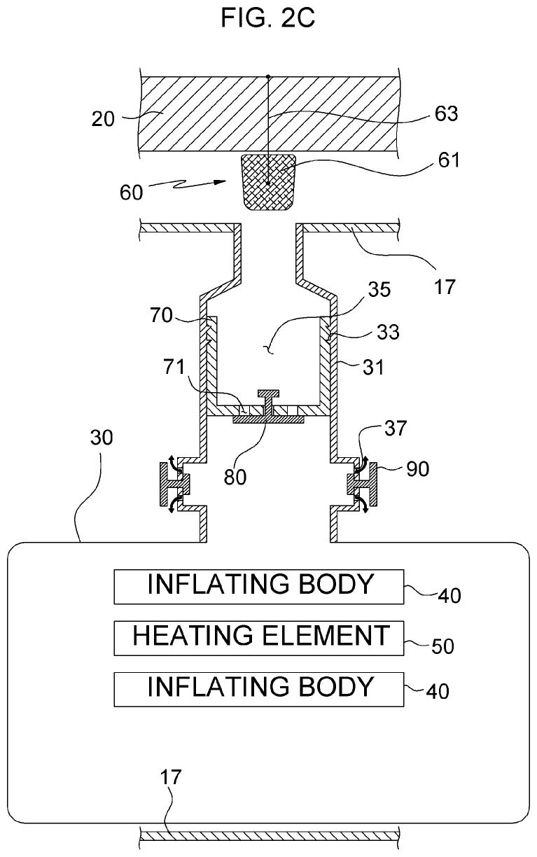

As shown in FIGS. 1A and 1B, the inflatable buoyant member 20 may be configured to be inflated inside the neck part 13 of the jacket 10.

The vacuum pack 30 is provided inside the sealed bag 17 and provided with a spout 31 for introducing water into the vacuum pack 30.

The vacuum pack 30 is provided with the self-triggering inflating body 40 and the heating element 50 therein. The vacuum pack 30 is in a vacuum state by vacuum processing after the self-triggering inflating body 40 and the heating element 50 are put inside the vacuum pack 30.

Preferably, the vacuum pack 30 may be positioned at the back part 11 of the jacket 10 contacting with water when the distress situation occurs, or the vacuum pack 30 may be positioned at a lower portion of the back part 11 or the front part 12.

The self-triggering inflating body 40 is an object having an inflation force. The self-triggering inflating body 40 is configured such that the self-triggering inflating body 40 that is compressed by vacuum pressure inside the vacuum pack 30 in the vacuum state is inflated by being recovered itself to an inflation state when the vacuum pack 30 is released from the vacuum state.

In more detail, when a stopper 61 of the spout 31 connected to the vacuum pack 30 is opened, the vacuum pack 30 is released from the vacuum state, thereby becoming a state in which outside material such as air, water or the like may flow into the vacuum pack 30 through the spout 31. Then, the self-triggering inflating body 40 is inflated and pushes opposite surfaces contacting each other (adjacent to each other) of the vacuum pack 30 to be away from each other. As the opposite surfaces of the vacuum pack 30 are away from each other, the inside volume of the vacuum pack 30 is increased to generate negative pressure, and the negative pressure occurring inside the vacuum pack 30 allows the outside material to flow into the vacuum pack 30 through the spout 31.

A sponge, a spring, and the like may be used as the self-triggering inflating body 40.

The heating element 50 is a material configured to generate heat by chemical reaction when the heating element 50 contacts with water. The heating element 50 is provided inside the vacuum pack 30.

When the vacuum pack 30 is released from the vacuum state, the self-triggering inflating body 40 is inflated and then water outside the vacuum pack 30 flows into the vacuum pack 30 through the spout 31. Thus, the heating element 50 generates heat by reacting with the inflow water. As the heating element 50 generates high temperature, the inflow water is changed into water vapor and the volume of the water is inflated.

The interlock-type opening member 60 is configured to operate in conjunction with the inflation of the inflatable buoyant member 20 so as to open an inlet opening of the spout 31 of the vacuum pack 30, so that water may flow into the vacuum pack 30.

The interlock-type opening member 60 may be a pull cord 63 connecting the stopper 61 provided in the inlet opening of the spout 31 to the inflatable buoyant member 20. When the inflatable buoyant member 20 is inflated, the pull cord 63 is moved in a direction of being away from the spout 31, thereby pulling the stopper 61. Accordingly, the stopper 61 is separated from the inlet opening of the spout 31.

As another example, the interlock-type opening member 60 may be a drill (not shown) that is connected to the inflatable buoyant member 20 and disposed such that a picked portion of the drill faces the stopper 61. Thus, when the inflatable buoyant member 20 is inflated, the picked portion thereof pierces the stopper 61, so that the stopper 61 may be torn and the inlet opening may be opened.

The cylinder 70 is provided inside an internal passage 35 of the spout 31 in a forward and rearward moveable manner.

Locking structures are respectively provided on a front-side outer wall of the cylinder 70 and a front-side inner wall of the spout 31 to be engaged with each other. When internal pressure of the vacuum pack 30 is increased, the cylinder 70 is moved forward to the inlet opening of the spout 31. Due to the forward movement of the cylinder 70, the locking structures are engaged with each other, thereby preventing the cylinder 70 from being moved rearward. The locking structures may be a saw tooth 33 and a saw tooth groove 73 as shown in the drawings.

The first check valve 80 is configured to open a flow path 71 provided in the cylinder 70. The flow path 71 of the cylinder 70 is provided to connect the inlet opening of the spout 31 to the inside of the vacuum pack 30. The first check valve 80 is configured to introduce outside water into the vacuum pack 30 through the inlet opening of the spout 31 and the flow path 71 of the cylinder 70.

The first check valve 80 is configured to open the flow path 71 of the cylinder 70 when external pressure of the vacuum pack 30 is higher than internal pressure thereof, so that outside water flows into the vacuum pack 30. In addition, the first check valve 80 is configured to close the flow path 71 of the cylinder 70 when internal pressure of the vacuum pack 30 is higher than external pressure thereof, so that water vapor inside the vacuum pack 30 does not flow out of the vacuum pack 30. The second check valve 90 is configured to open and close a vapor outlet 37 provided in the spout 31. The vapor outlet 37 of the spout 31 is provided to connect the inside of the vacuum pack 30 to the inside of the sealed bag 17, so that water vapor generated in the vacuum pack 30 may be discharged to the sealed bag 17.

Hereinbelow, when a water distressed person with the life jacket having the above-described configuration according to the present disclosure meets with water distress, operational mechanism of the life jacket will be described.

First, the water distressed person fallen in water blows air into the floating tube (that is, the inflatable buoyant member 20) by having the hose in his/her mouth, or presses the operation button so that gas is injected from the compressed gas container to the floating tube to inflate the floating tube.

When the floating tube is inflated by the inflatable buoyant member 20, the pull cord 63 pulls the stopper 61 blocking the inlet opening of the spout 31 to open the inlet opening of the spout 31.

When the inlet opening of the spout 31 is opened, the vacuum pack 30 is released from the vacuum state. Then, the self-triggering inflating body 40 inside the vacuum pack 30 is inflated and pushes the opposite surfaces of the vacuum pack 30 to be away from each other, thus negative pressure is generated in the vacuum pack 30. Accordingly, the first check valve 80 opens the flow path of the cylinder 70 and outside water flows into the vacuum pack 30 through the inlet opening and the flow path of the spout 31.

When the water flows into the vacuum pack 30, the heating element 50 undergoes high temperature exothermic reaction by contacting with the inflow water, so that the water is changed into water vapor.

When the water vapor is generated, internal pressure of the vacuum pack 30 is increased. When internal pressure of the vacuum pack 30 is higher than external pressure thereof, the first check valve 80 closes the flow path of the cylinder 70, and the cylinder 70 is moved forward along the internal passage 35 of the spout 31. Then, as the saw tooth 33 and the saw tooth groove 73 are engaged with each other, the cylinder 70 blocks the inlet opening of the spout 31 so that no more outside water flows into the vacuum pack 30.

When the cylinder 70 is moved forward, the second check valve 90 is exposed and the vapor outlet 37 of the spout 31 is opened by internal pressure of the vacuum pack 30. When the vapor outlet 37 is opened, the water vapor generated inside the vacuum pack 30 flows through the vapor outlet 37 into the sealed bag 17 and then is spread throughout the sealed bag 17.

The hot water vapor flowing into the sealed bag 17 increases the temperature of the jacket 10 worn by the water distressed person to prevent death from hypothermia, and the inflated water vapor provides buoyancy to the jacket 10.

Although the preferred embodiment of the present disclosure has been described for illustrative purposes, those skilled in the art will appreciate that various modifications, additions and substitutions are possible, without departing from the scope and spirit of the invention as disclosed in the accompanying claims.

What is claimed is:

1. A life jacket having a function of maintaining body temperature, the life jacket comprising:
an inflatable buoyant member configured to be inflated to provide buoyancy;
a jacket including a sealed bag, and being wearable on an upper body of a user;
a vacuum pack having a spout and provided inside the sealed bag, the spout being configured such that an end thereof is exposed to an outside of the jacket;
a self-triggering inflating body provided inside the vacuum pack;
a heating element configured to generate heat by reacting with water flowing into the vacuum pack; and
an interlock-type opening member, which is configured to open a stopper by being in conjunction with inflation of the inflatable buoyant member, the stopper being configured to normally close an inlet opening of the spout.

2. The life jacket of claim 1, further comprising:
a cylinder provided in an internal passage of the spout; and
a first check valve configured to open and close a flow path of the cylinder by using pressure difference, the flow path connecting the inlet opening of the spout to an inside of the vacuum pack.

3. The life jacket of claim 2, wherein when pressure inside the vacuum pack is increased due to reaction of the heating element, the cylinder is moved forward to the inlet opening of the spout along the internal passage of the spout, and
a locking structure is provided on each of an inner wall of the spout and an outer wall of the cylinder so that the inner wall of the spout and the outer wall of the cylinder are locked to each other by the locking structure.

4. The life jacket of claim 1, wherein the spout comprises a second check valve, the second check valve being configured to be opened when pressure inside the vacuum pack is increased, thereby allowing water vapor generated by the heat of the heating element to be discharged to the sealed bag.
